(19) United States
(12) Patent Application Publication
(10) Pub. No.: US 2016/0167259 A1
(43) Pub. Date: Jun. 16, 2016

(54) COATING SYSTEM AND METHOD

(71) Applicant: Tecton Products, LLC, Fargo, ND (US)

(72) Inventors: Robert P. Plagemann, Fargo, ND (US); Neena Ravindran, Fargo, ND (US)

(21) Appl. No.: 14/969,396

(22) Filed: Dec. 15, 2015

Related U.S. Application Data
(60) Provisional application No. 62/091,786, filed on Dec. 15, 2014.

(51) Int. Cl. B29C 37/00; B29C 70/54; C09D 133/00; B29C 70/52; C08G 18/06; C09J 177/00

(52) U.S. Cl. CPC B29C 37/0025; C08G 18/06; C09J 177/00; C09D 133/00; B29C 70/521; B29C 70/527; B29C 70/545; B29K 2075/00

(57) ABSTRACT

A method of manufacturing a coated article comprises injecting a feedstock with a polymer resin to provide a resin-injected feedstock, pulling the resin-injected feedstock through a pultrusion die to form a pultrusion substrate having one or more profile surfaces, adhering one or more adhesive materials onto at least a portion the one or more profile surfaces to form one or more adhesive tie layers on the pultrusion substrate, and applying one or more coating materials onto the one or more adhesive tie layers to form one or more coating layers on the one or more adhesive tie layers to provide a coated pultrusion article, wherein an adhesion strength between the one or more coating layers and the one or more adhesive tie layers is higher than a corresponding adhesion strength would be between the one or more coating layers and the pultrusion substrate.

### CROSS-REFERENCE TO RELATED APPLICATION

This application claims the benefit of priority under 35 U.S.C. §119(e) of U.S. Provisional Patent Application 62/091,786 filed on Dec. 15, 2014, which application is incorporated by reference herein in its entirety.

### BACKGROUND

Pultrusion is a continuous process for manufacturing a composite material that entails simultaneously pulling a reinforcement material through a resin impregnating processing equipment and peripheral manufacturing equipment and cross-head extruding the composite material onto a component. Pultrusion systems used in industry can include a resin mixer and a resin impregnator for impregnating or injecting the resin into the reinforcement material, such as one or more reinforcement fibers. The resin impregnated reinforcement material can be pulled through a heated die (e.g., a pultrusion die) to form a substrate. The resulting substrate formed by the pultrusion process can include a three-dimensional shape formed through one or more pultrusion dies.

In various examples, a pultrusion process can include coating the substrate, for example with a coating that can improve weatherability, durability, and aesthetics of the finished article.

### SUMMARY

The present disclosure describes systems and methods for producing one or more pultrusion articles having a coating. The present disclosure also describes coated pultrusion articles, e.g., made from one or more of the systems or methods described herein. The systems and methods described herein provide for coating a substrate, such as a pultrusion substrate, having a particularly smooth substrate surface or a surface with a particularly low surface energy upon which other coating systems or methods typically fail to form a sufficiently strong mechanical bond.

The present inventors have recognized, among other things, that a problem to be solved can include applying a coating material to a substrate material that is not conducive to reception of a coating. Stated another way, the problem includes minimizing delamination and failure to couple the coating material to the substrate during production. In some examples, it has been found that a substrate material having a very smooth surface (e.g., that is less porous or less rough) is difficult for a coating material to bond to. In some examples, substrate materials with relatively low surface energies are difficult for a coating material to sufficiently contact and wet, resulting in insufficient bonding strength between the coating material and the substrate material. Some substrate materials can have relatively smooth surfaces or relatively low surface energy, or both, as compared to some other polymeric substrates. For example, polyurethane-based pultrusion substrates can be substantially smoother and have substantially lower surface energy as compared to a polyester pultrusion substrate (e.g., the surfaces of the polyurethane-based substrate can be less porous or less rough than surfaces formed by other polymers). The relatively smooth and low-surface energy nature of a polyurethane-based pultrusion substrate in some examples is believed to be at least partially due to polyurethane tending to have a higher resin density at the surface being coated than other polymers.

Other polymer systems can also form substrates with surfaces that are difficult to bond with a coating material. A smoother substrate or one with a lower surface energy can make it challenging to adhere a coating to the substrate. For example, a relatively smooth surface has minimal surface roughness and, accordingly, substantially fewer microstructures onto which the coating material can mechanically lock. In some examples, differences in surface energy between the substrate surface and the coating can also be, in an example, unfavorable for adhesion of the coating to the substrate surface.

In an example, the present subject matter can provide a solution to this problem, such as by providing one or more adhesive tie layers made from a material that can sufficiently bond to a surface of the substrate that is relatively smooth, has a relatively low surface energy, or both. The one or more adhesive tie layers can be applied to a portion or portions of the substrate to which it is desired to provide one or more improved properties, such as at least one of improved aesthetics, improved color, or improved weatherability. The one or more adhesive tie layers provides for higher bonding strength of the coating material to the substrate surface than could be achieved directly between the coating material and the substrate surface without the one or more adhesive tie layers. The coating is applied to the one or more adhesive tie layers to provide a coated article. In some examples, the one or more adhesive tie layers provide for one or more of: improved mechanical bonding of the coating material to the substrate or improved chemical bonding between the material of the one or more adhesive tie layers and the substrate material or between the coating material and the material of the one or more adhesive tie layers, or both. Stated another way, in some examples, the one or more adhesive tie layers provide an interface between a substrate surface that is relatively smooth or that has a relatively low surface energy, or both, and the coating material that provides a higher bonding strength and a more secure coupling therebetween than can be achieved between the substrate and the coating material without the one or more adhesive tie layers.

The present inventors have recognized, among other things, that another problem to be solved can include coating a substrate having a smooth surface, e.g., a polyurethane substrate, in a continuous in-line process. Coating processes that were previously used to coat onto highly-smooth polymer substrate surfaces, such as those on a polyurethane pultrusion substrate, have included off-line or two step processes wherein a pultruded substrate is removed from the continuous manufacturing process, e.g., taken “offline,” and moved to a coating system, such as a powder coating system or liquid painting system. The coated substrate is then dried, such as via baking or holding within a relatively dry environment, so that the powder or paint coating is dried and secured the powder to the pultruded components. Off-line processing used for powder coating or painting processes require greater manufacturing space and longer cycle times to produce a coated article, increasing the cost and decreasing the efficiency of the process.

In an example, the present subject matter can provide a solution to this problem, such as by providing one or more extrudable adhesives, such as one or more cross-head extrudable adhesive materials, that can be applied to a portion or portions of a substrate (e.g., a polyurethane substrate) as one or more adhesive tie layers. In an example, the one or more adhesive materials that forms the one or more adhesive tie layers are applied to the substrate at a temperature or temperatures that minimize or eliminate thermal degradation of the substrate material. For example, the substrate can be exposed to a heat source prior to application of the one or more adhesive materials, for instance immediately downstream from a pultrusion process to impregnate a resin into a feedstock reinforcement material that can form the substrate. The temperature of at least the one or more adhesive materials (e.g., in the form of the one or more adhesive tie layers on the substrate) optionally is maintained during application of one or more coating materials to form a coating on the one or more adhesive tie layers. For example, the substrate and the adhesive tie layer can be heated continuously until application of the one or more coating materials. In an example, the substrate or the one or more adhesive materials, or both, can be heated prior to the application of the one or more coating materials. In an example, a temperature of at least the one or more adhesive tie layers at the time of coating with the one or more coating materials is maintained to ensure bonding between the coating material and the adhesive tie layer despite heat transfer to the surrounding environment. In an example, a profile of the substrate can be consistent from the pultrusion die, e.g., as a lineal member extending from the pultrusion die, such that the profile can be cut to form an article having a consistent shape and thickness.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A is a schematic diagram of an example system for manufacturing an example elongate pultrusion article with a coating.

FIG. 1B is a schematic diagram of another example system for manufacturing an example elongate pultrusion article with a coating.

FIGS. 2A and 2B are cross-sectional views of example pultrusion articles, for example that can be manufactured by the examples systems of FIG. 1A or 1B.

FIGS. 3A-3C are cross-sectional views of example pultrusion articles taken along line 4-4 in FIG. 2A.

FIG. 4 is a diagram of an example method of manufacturing an example elongate pultrusion article.

FIG. 5A shows a scanning electron micrograph of a substrate surface of a relatively rough-surfaced pultrusion article.

FIG. 5B shows a scanning electron micrograph of a substrate surface of a relatively smooth-surfaced pultrusion article.

### DETAILED DESCRIPTION

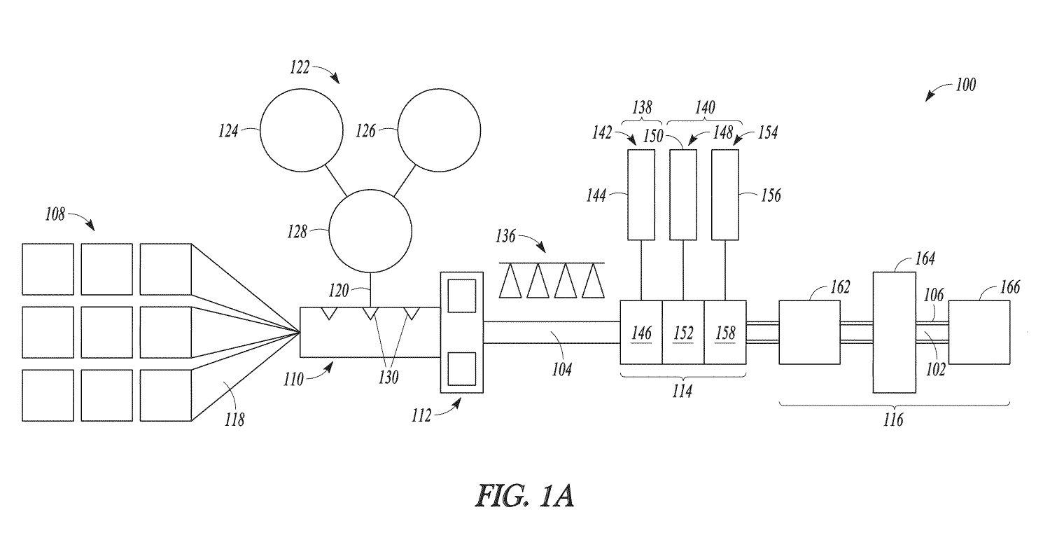

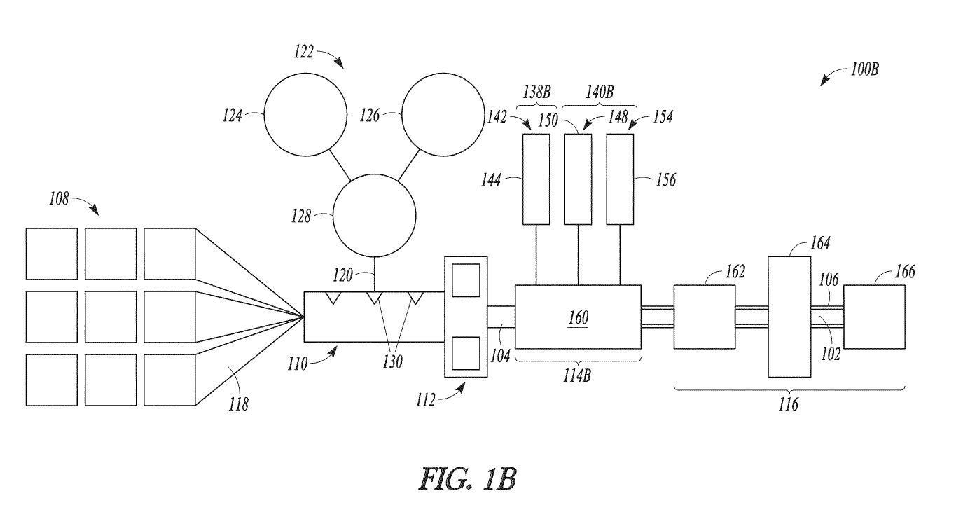

FIG. 1A illustrates an example of a system 100 for manufacturing a coated pultrusion article 102. In an example, the system 100 manufactures a pultruded substrate 104 and applies a coating 106 to the substrate 104, e.g., wherein the coating 106 can be selected to provide one or more improved properties, such as at least one of improved aesthetics, improved color, or improved weatherability compared to the uncoated substrate 104. Therefore, for the sake of clarity and brevity, the system 100 may be referred to herein as a pultrusion and coating system 100, and the substrate 104 may be referred to herein as a pultrusion substrate 104. The pultrusion and coating system 100 can be used to apply a coating to a substrate that has one or more surfaces that are relatively smooth or that have a relatively low surface energy, such as a pultruded polyurethane substrate. The systems and methods described herein can provide for adequate bonding of a coating material to surfaces that are relatively smooth or have a relatively low-surface energy, or both. In examples, the terms “highly smooth,” “relatively smooth,” and/or “low surface energy” or “relatively low surface energy,” as used herein, can refer to a surface having a water contact angle of less than 65°, such as less than about 60°, for example less than 55°. For example, the inventors have found that one example of a polyurethane-based pultrusion substrate had a water contact angle in the range of about 45° to about 55°, when measured by the contact angle measurement instrument having the model number FTA 125, sold by First Ten Angstroms, Inc., Portsmouth, Va., USA. It was found to be difficult to bond coating materials directly to the example polyurethane-based substrate with the water contact angle of about 45° to about 55°. In contrast, an example polyester-based pultrusion substrate, to which it has been found to be much easier to bond coating materials, was found to have a water contact angle in the range of about 65° to about 75°. Without wishing to be bound by any theory, the present inventors believe that the example systems and processes described herein bridge this distinct difference in surface energy can provide for coating adhesion and, therefore, provide for bonding to substrate materials that, heretofore, could not be used for many application of pultrusion articles.

In an example, the pultrusion and coating system 100 comprises a feed system 108, a resin-injection assembly 110, a pultrusion die 112, a coating system 114, and a finishing system 116. The feed system 108 can provide a feedstock 118 to the pultrusion and coating system 100, and in particular to the resin-injection assembly 110. The feedstock 118 can comprise one or more reinforcement structures to which a resin can be applied in order to provide a composite material in the form of the pultrusion substrate 104. In an example, the one or more reinforcement structures of the feedstock 118 can comprise one or more continuous fibers, such as one or more reinforcing fibers. Examples of the one or more reinforcing fibers that can be used as the reinforcement feedstock 118 in the pultrusion and coating system 100 include, but are not limited to, glass fibers, basalt fibers, carbon aramid fibers, Kevlar fibers, natural fibers, such as flax or hemp, among others.

The feed system 108 can include one or more systems to store and feed the feedstock 118 in such a manner that the feedstock 118 is continuously fed to the rest of the pultrusion and coating system 100. In an example, the feed system 108 includes a carting system and an aligning system that delivers or provides the feedstock 118 to another portion of the pultrusion and coating system 100. In an example wherein the feedstock 118 comprises one or more continuous reinforcing fibers, each of the one or more fibers can be stored as a roving that is continuously fed to the other portion of the pultrusion and coating system 100.

In an example, the feed system 108 can deliver or provide the feedstock 118 to the resin-injection assembly 110. The resin-injection assembly 110 can include a resin feed device or devices to feed a polymer resin 120 to the feedstock 118, such as one or more resins that can form a polyurethane or polyurethane-containing mixture or blend. In an example, the resin-injection assembly 110 can inject the polymer resin 120 into contact with the feedstock 118. The resin-injection assembly 110 can sufficiently inject the polymer resin 120 so that the feedstock 118 is at least partially impregnated with and at least partially surrounded by the polymer resin 120. In an example, the polymer resin 120 that is applied to the feedstock 118 can include one or more fillers to modify physical properties of the polymer formed from the resin and of the pultrusion substrate 104. Examples of fillers that can be used in the polymer resin 120 include, but are not limited to, particles of calcium carbonate (CaCO₃), alumina trihydrate (Al₂O₃.3 H₂O), talc (e.g., a mineral form of hydrated magnesium silicate, H₂Mg₃(SiO₃)₄), clay, or one or more types of glass filler particles (such as glass spheres). In an example, the resin-injection assembly 110 includes a feedstock alignment system to align the feedstock 118 in a desired configuration for resin impregnation.

The polymer resin 120 can be pre-mixed or the resin-injection assembly 110 can include a resin-mixing system 122 that mixes one or more resin constituents to form a resin mixture having a specified composition. The resin-mixing system 122 can include a plurality of storage vessels each supplying a resin constituent. In an example, the resin-mixing system 122 includes a first resin storage vessel 124 for a first resin constituent and a second resin storage vessel 126 for a second resin constituent. The resin-mixing system 122 can optionally further include one or more additional storage vessels for one or more additional resin constituents, such as a third storage vessel for a third resin constituent, a fourth storage vessel for a fourth resin constituent, and so on. The plurality of storage vessels can be communicatively coupled to a mixing apparatus 128, such as a mixing vessel or a mixing device, wherein each corresponding resin constituent from the plurality of storage vessels 124, 126 can be mixed to provide the polymer resin 120 having the specified composition.

In an example, the polymer resin 120 comprises a polyurethane-based resin to form a polyurethane based pultrusion substrate 104. In such an example, a first polyurethane constituent can comprise one or more polyols such that the first resin storage vessel 124 can be one or more polyol storage vessels. A second polyurethane constituent can comprise one or more isocyanates such that the second resin storage vessel 126 can be one or more isocyanate storage vessels. The one or more polyol storage vessels 122 and the one or more isocyanate storage vessels 124 can be communicatively coupled to the mixing apparatus 128 where the one or more polyols from the one or more polyol storage vessels 122 and the one or more isocyanates from the one or more isocyanate storage vessels 124 can be mixed to form a polyurethane-based polymer resin 120.

The resin-mixing system 122 can include a pumping system that is communicatively coupled to the mixing apparatus 128. The pumping system can withdraw the polymer resin 120 from the mixing apparatus 128 and feed the resin mixture to one or more resin nozzles 130. Each of the one or more resin nozzles 130 can inject or otherwise apply the polymer resin 120 to the feedstock 118.

In an example, the feed system 108 can include one or more heating devices to heat at least one of: (a) one or more of the resin constituents, e.g., before mixing the one or more resin constituents; (b) the resin mixture within the mixing apparatus, e.g., after mixing of the one or more resin constituents; or (c) the resin mixture in a feed line between the mixing apparatus and the one or more resin nozzles, e.g., after withdrawing the resin mixture with the pumping system. Each of the one or more heating devices can heat the component being heated (e.g., one or more of the resin constituents or the resin mixture) to a specified temperature, e.g., to be more conducive to polymerization and formation of the polymer of the pultrusion substrate 104.

The feedstock 118 can be pulled or otherwise forced through the pultrusion die 112 to shape the feedstock 118 into a desired shape in the form of the pultrusion substrate 104. The pultrusion die 112 can produce a three-dimensional (3D) profile 132 of the resin-injected feedstock 118. Examples of profiles 132 that can be formed by the resin-injection assembly 110 and the pultrusion die 112 include, but are not limited to, pultrusion articles in the form of an architectural fenestration component, a building component, a solar component, a furniture component, or a refrigeration component. The pultrusion die 112 can result in the pultrusion substrate 104 having one or more profile surfaces 130 in a specified configuration.

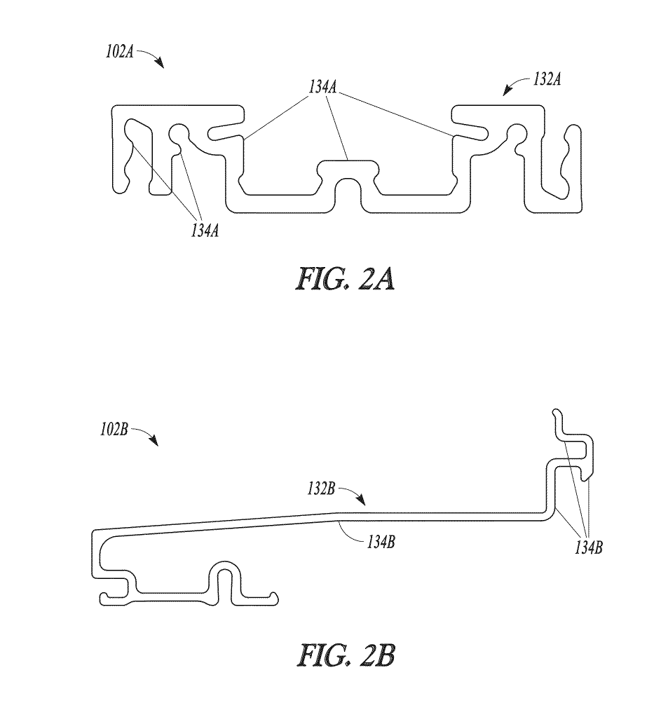

FIGS. 2A and 2B show two examples of coated articles 102A and 102B formed by coating pultrusion substrates 104A and 104B, wherein the pultrusion substrates 104A, 104B provide two examples of three-dimensional profiles 132A, 132B, respectively, that can be formed, for example using the pultrusion die 112. FIG. 2A shows a profile view of an example profile 132A for a modular patio door sill, while FIG. 2B shows a profile view of an example profile 132B for a window frame cladding. The specific pultrusion substrates 104A and 104B shown in FIGS. 2A and 2B are included as examples for illustration purposes only. As will be understood by a person of ordinary skill in the art, the systems, methods, and resulting articles described herein are not limited to the specific pultrusion profiles 132A and 132B or forms shown in FIGS. 2A and 2B. The profile 132 formed by pultruding the feedstock 118 through the pultrusion die 112 can include one or more profile surfaces 134A, 134B, e.g., outer surfaces of the pultrusion substrates 104A, 104B (best seen in FIGS. 2A and 2B).

The pultrusion die 112 can include one or more associated heating devices, such as one or more heaters, for example one or more integral die heaters or one or more heaters external to the pultrusion die 112, or both. The one or more heaters associated with the pultrusion die 112 can provide for thickening or gelling, or both, of the polymer resin, for example by initiating or continuing polymerization of the one or more resin constituents in the polymer resin. The one or more heating devices can also provide for full or partial curing of the polymer resin within or substantially immediately downstream of the pultrusion die 112.

In an example, the pultrusion and coating system 100 can include one or more in-line heaters 136 to heat the pultrusion substrate 104 downstream of the pultrusion die 112. The one or more heaters 136 can be configured, or can be part of a temperature control system, to control or maintain a temperature of the pultrusion substrate 104 downstream of the pultrusion die 112 and before the pultrusion substrate 104 enters the coating system 114. In an example, the one or more heaters 136 can be configured to control or maintain a temperature of the 104 so that the portions of the one or more profile surfaces 134 to which one or more adhesive materials are to be applied, e.g., to form and the one or more adhesive tie layers as described in more detail below, will be at a specified adhesion-application temperature. The specified adhesion-application temperature can be a temperature that will perform one or more of the following: improved adhesion of the adhesive material applied to the one or more profile surfaces 134; or improved formation of the one or more adhesive tie layers, e.g., via setting, gelling, or other polymerization of the one or more adhesive materials after application to the pultrusion substrate 104. In an example, the one or more heaters 136 can comprise one or more infrared heaters that emit infrared radiation onto the pultrusion substrate 104. The pultrusion and coating system 100 can also include temperature sensors to measure a temperature of the pultrusion substrate 104 and to control an output of the one or more heaters 136 based on a measured temperature of the pultrusion substrate 104, e.g., in the manner of a feedback control loop.

In an alternative example of a pultrusion and coating system 100B, shown in FIG. 1B, the one or more heaters 136 can be omitted, and the coating system 114, and in particular the entrance to the adhesive storage vessel 144, can be located in close proximity to an exit of the pultrusion die 112, and an in-line heater (like the one or more heaters 136 show in FIG. 1A) are omitted. In the pultrusion and coating system 100B shown in FIG. 1B, the temperature of the pultrusion substrate 104 exiting the pultrusion die 112 can be controlled at the pultrusion die 112, e.g., with a heater within or immediately upstream of the pultrusion die 112 that is controlled to not only provide a temperature that is conducive to setting or gelling of the matrix polymer, but also to provide a temperature of the pultrusion substrate 104 exiting the pultrusion die 112 that is conducive to adhesion by the one or more adhesive materials.

Returning to FIG. 1A, as noted above, the pultrusion and coating system 100 includes a coating system 114 to apply a coating 106 onto the pultrusion substrate 104, e.g., onto at least a portion of one or more profile surfaces 134. As described in more detail below, the coating 106 can include one or more coating layers that are adhered to the pultrusion substrate 104 with one or more adhesive tie layers. As used herein, the term “adhesive tie layer” or “tie layer,” can refer to one or more layers between the pultrusion substrate 104 and one or more coating layers. In an example, the one or more adhesive tie layers provide an adhesive strength between the one or more coating layers and the pultrusion substrate 104 that is higher than could be possible if the one or more coating layers were applied directly to the pultrusion substrate 104. Therefore, in an example the coating system 114 can include an adhesive-application assembly 138 to apply one or more adhesive materials onto at least a portion of the profile surfaces 134 in order to form the one or more adhesive tie layers. The coating system 114 can also include a coating-material application assembly 140 to apply one or more coating materials onto the one or more adhesive tie layers in order to form the one or more coating layers.

In an example, the adhesive-application assembly 138 applies one or more extrudable adhesive materials onto the pultrusion substrate 104 so that the one or more extrudable adhesive materials form one or more adhesive tie layers on the pultrusion substrate 104. In an example, the one or more extrudable adhesive materials include an extrudable thermoplastic adhesive. In some examples, the extrudable thermoplastic adhesive includes, but is not limited to, one or more of a polyamide, a copolyamide, a block copolymer of a polyamide and a polyester, an acrylic, a stryrenic or butadiene-based block copolymer, a functionalized olefin, a functionalized acrylic, polylactic acid (PLA), or acrylonitrile-butadiene-styrene (ABS). In an example with a polyurethane-based pultrusion substrate 104 and an acrylic-based coating layer, copolyamide-based adhesive materials were found to be particularly useful, such as a copolyamide blend, for example a copolyamide blend of two or more different and varying polyamide repeat units. An example of such a copolyamide-based adhesive material is the extrudable polyamide adhesive blend sold under the trade name PLATAMID by Arkema Inc., Colombes, France.

In an example of one or more extrudable adhesive materials, the adhesive-application assembly 138 can include an adhesive extruder 142 comprising at least one adhesive storage vessel 144 and an adhesive die 146. The at least one adhesive storage vessel 144 stores the one or more adhesive materials for delivery to the adhesive die 146, which can include one or more adhesive dies if needed. In an example, the adhesive-application assembly 138 includes an adhesive heater (such as a stand-alone heater, a heater as part of the adhesive die 146, or a heater in the adhesive extruder 142. The adhesive heater can heat the one or more adhesive materials to the adhesive-application temperature, described above. In an example, the adhesive-application temperature is at least about the temperature of the pultrusion substrate 104.

The one or more adhesive materials can be any material that can adhere to the pultrusion substrate 104 and to the one or more coating materials that form the one or more coating layers. The one or more adhesive materials can be applied to the pultrusion substrate 104 in a continuous or semi-continuous in-line process, e.g., that is in line with one or both of the pultrusion die 112 and the coating-material application assembly 140. An in-line process can provide at least the benefits of space reduction, less time consumption, and a simpler process as compared to other methods of coating, such as powder coating or painting. Further, as shown in Table 1, the adhesive material applied by the in-line process of the adhesive-application assembly 138 can provide greater adhesion strength, as compared to a powder coating applied directly to the pultrusion substrate 104.

TABLE 1
Comparison between powder coating and
adhesive adhesion strength

| | Powder | Adhesive |
|---|---|---|
| | Coating (psi) | Coating (psi) |
| Range (High) | 312-219 | 1260-1032 |
| Range (Mid) | 180-162 | 815-632 |
| Range (Low) | 140-134 | 583-415 |
| Overall Average | 191 | 800 |
| Overall Standard | 56.69 (30%) | 265.01 (33%) |
| Deviation (% of | | |
| Overall Average) | | |

Continuing with FIG. 1A, the coating system 114 of the pultrusion and coating system 100 can include a coating-material application assembly 140 to apply one or more coating materials to form one or more coating layers to the one or more adhesive tie layers applied at least to a portion of the profile surfaces 134 of the pultrusion substrate 104 to provide the coated pultrusion article 102. The coating-material application assembly 140 can include a coating extruder 148 that includes a coating material storage vessel 150 and a coating material die 152.

In an example, the coating-material application assembly 140 applies a single coating layer onto the one or more adhesive tie layers formed from the one or more adhesive materials (e.g., the one or more extrudable adhesive materials described above) in order to couple the single coating layer to the pultrusion substrate 104 to form the coated pultrusion article 102. Therefore, in an example, the coating-material application assembly 140 may comprise only a single coating extruder 148 of a single coating material storage vessel 150 feeding a single coating material die 152. In another example, the coating-material application assembly 140 applies a plurality of coating layers onto the one or more tie layers to form the coated pultrusion article 102. Each layer of the plurality of coating layers can be formed from a different coating material composition, or each layer can comprise the same coating composition. In the example shown in FIGS. 1A and 1B, the pultrusion and coating system 100 is configured to form a coating 106 comprising a single adhesive tie layer and two coating layers. In such an example, the adhesive-application assembly 138 includes a single adhesive extruder 142 to apply the single adhesive tie layer. In the same example system 100, the coating-material application assembly 140 can include a first coating extruder 148 comprising a first coating material storage vessel 150 and a first coating die 152 to form a first coating layer, e.g., on top of the adhesive tie layer, and a second coating extruder 154 comprising a second coating material storage vessel 156 and a second coating die 158 to form a second coating layer, e.g., on top of the first coating layer. Different example configurations of one coating layer or two coating layers are described below. In various examples, the coating-material application assembly 140 includes a coating die 152, 158 for each coating layer or includes a co-extrusion die to apply two or more coating layers at substantially the same time to the one or more adhesive tie layers applied to the pultrusion substrate 104. In an example, the adhesive application assembly and the coating assembly share a co-extrusion die for applying the adhesive to the polyurethane substrate and the coating to the applied adhesive.

In an example, two or more of the one or more adhesive tie layers and the one or more coating layers can be applied by a co-extrusion die that applies two or more materials in substantially the same operation. In an example system that applies two or more coating layers from the coating-material application assembly 140, the coating layers can be applied from a co-extrusion die. Similarly, as shown in the example pultrusion and coating system 100B of FIG. 1B, the adhesive-application assembly 138B and the coating-material application assembly 140B can be combined such that the one or more adhesive tie layers and the one or more coating layers can be applied from a common co-extrusion die 160. Examples of materials that can form each of the one or more coating layers include, but are not limited to, at least one of: one or more acrylics, one or more bioplastics, polyvinylchloride, polyvinylidene fluoride, acrylonitrile-styrene-acrylate, weather stock (e.g., weather capping or a weather resistant coating), aesthetic coatings, texturization coatings, one or more clear-coat materials, one or more primer compositions, or blends thereof.

After the one or more adhesive tie layers are applied by the adhesive-application assembly 138 and the one or more coating layers are applied by the coating-material application assembly 140, the coated pultrusion article 102 can be processed by the finishing system 116. In an example, the finishing system 116 can include one or more of a cooling assembly 162 or a pulling mechanism 164. The coated pultrusion article 102 can be cooled by the cooling assembly 162. The cooling assembly 162 can apply a cooling medium to the coated pultrusion article 102, such as forced air (e.g., a fan or nozzle providing air at a temperature less than the coated profile), ambient air (e.g., non-forced air), or a cooling liquid, such as in an immersion bath or sprayed onto the coated profile.

The pulling mechanism 164 can pull the coated pultrusion article 102 from the pultrusion and coating system 100, which in turn will pull the pultrusion substrate 104 through the adhesive-application assembly 138 and the coating-material application assembly 140, which in turn will pull the feedstock 118 from the feed system 108 through the resin-injection assembly 110. The rate that the pulling mechanism 164 can move the coated pultrusion article 102, pultrusion substrate 104, and feedstock 118 through the pultrusion and coating system 100 can be variable according to a specified production rate, a specific three-dimensional profile 132 of the coated pultrusion article 102 being produced, the materials being used for the pultrusion substrate 104 (e.g., the feedstock 118 and the polymer resin 120), the one or more adhesive tie layers, and the one or more coating layers, factory conditions, or the like. In various examples, the finishing system 116 can include additional processing apparatuses, such as, but not limited to a cutting mechanism 166 to section the coated pultrusion article 102 to a specified size (e.g. to a predetermined length), a stacking assembly to package the cut coated pultrusion articles 102 for shipment, and the like.

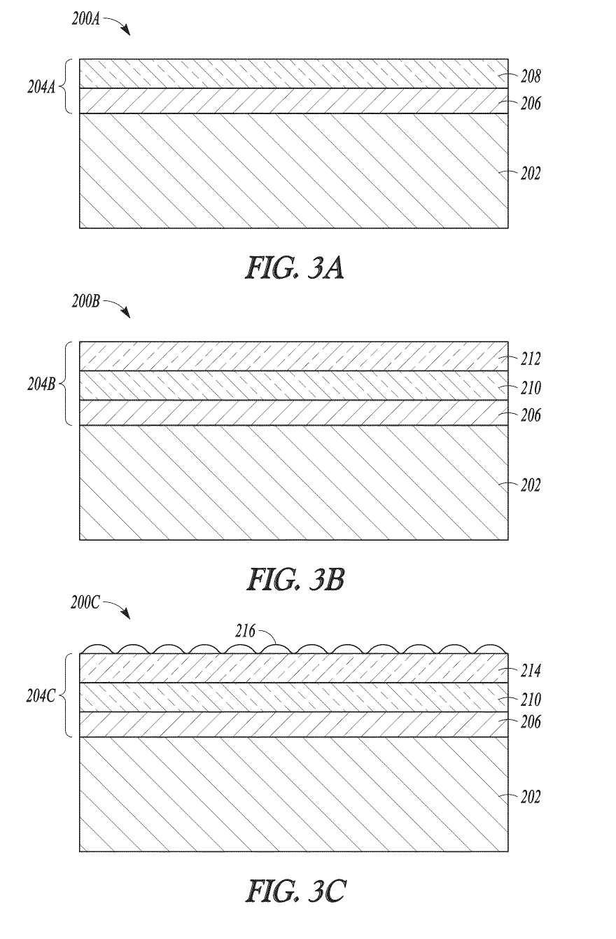

FIGS. 3A, 3B, and 3C show cross-sectional views of various examples of coated pultrusion articles 200A, 200B, 200C formed by coating a pultrusion substrate 202 with a respective coating 204A, 204B, 204C. The cross-sections of FIGS. 3A-3C are enlarged to show the structures that make up the example coated pultrusion articles 200A-200C, and are not necessarily drawn to scale. The example coated pultrusion articles 200A-200C in FIGS. 3A-3C, respectively, could be any pultrusion article in accordance with the present disclosure, e.g., any coated pultrusion article 102 that can be produced by the pultrusion and coating system 100 described with respect to FIGS. 1A and 1B. For example, the pultrusion substrate 202 in all three example coated pultrusion articles 200A, 200B, and 200C can comprise a resin injected feedstock that has been shaped, e.g., by pultrusion through a pultrusion die, into a three-dimensional profile having one or more profile surfaces, including, but not limited to coated forms of the example pultrusion substrates 104A and 104B shown in FIGS. 2A and 2B. In various examples, the pultrusion substrate 202 can include up to about 85% reinforcing feedstock 118 (e.g., reinforcing fiber), such as about 80% reinforcing feedstock, by weight. For purposes of illustration, the coated pultrusion articles 200A-200C in FIGS. 3A-3C are shown as a cross section of a coated modular patio door sill 102A of FIG. 2A.

Each example coated pultrusion article 200A, 200B, and 200C shows an example coating 204A, 204B, and 204C, respectively, that can be coated onto the pultrusion substrate 202 for various applications and desired properties. Each coating 204A, 204B, and 204C includes an adhesive tie layer 206 that provides an adhesive interface between the pultrusion substrate 202 and the one or more coating layers of the adhesive tie layer 206.

FIG. 3A shows an example coated pultrusion article 200A comprising a coating 204A with an adhesive tie layer 206 bonding a single coating layer 208 to the pultrusion substrate 202. The single coating layer 208 can be made from an acrylic or other material capable of providing at least one of: improved toughness or scratch resistance to the pultrusion substrate 202, improved visual appearance for the pultrusion substrate 202, or improved weatherability of the pultrusion substrate 202. In an example, the single coating layer 208 comprises at least one of: a weather resistant layer, a clear-coat layer, an acrylic coating, or the like.

FIG. 3B shows an example coated pultrusion article 200B with a coating 204B comprising an adhesive tie layer 206 and a two-layered stack of coating layers comprising a first coating layer 210 comprising a first coating material and a second coating layer 212 comprising a second coating material. The first and second coating materials can comprise different coating materials or compositions or can be the same coating material or composition. In an example, one or both of the first coating layer 210 and the second coating layer 212 comprises at least one of: a weather resistant layer, a clear-coat layer, an acrylic coating, or the like. In an example, the first coating layer 210, e.g., the innermost coating layer 210, can comprise an aesthetic coating layer, such as a colorized layer. The second coating layer 212, e.g., the outermost coating layer 212, can provide for improved weathering protection of the first coating layer 210 and the underlying pultrusion substrate 202. In an example, the second coating layer 212 is a weather capping (e.g., weather stock), that is weather resistant and provides protection including, but not limited to, at least one of UV protection, precipitation protection, temperature protection, or the like. The presence of the second coating layer 212 can allow the first coating layer 210 to have lower levels of color and gloss while maintaining the overall desired color and gloss appearance for the coated pultrusion article 200B because the first coating layer 210 can be less impacted by weather effects. In a coated article that did not include a second coating layer 212, the outer surface of the first coating layer 210 would tend to chalk. In an example, the second coating layer 212 is a clear-coat layer resistant to chalking.

FIG. 3C shows another example coated pultrusion article 200C with a coating 204C that is similar to the coating 204B on the coated pultrusion article 200B shown in FIG. 2B. The coated pultrusion article 200C includes the adhesive tie layer 206 and also includes a two-layer stack of coating layers. Like the coating 204B, the coating 204C of the coated pultrusion article 200C in FIG. 3C includes a first coating layer 210, but rather than the second coating layer 212 shown in FIG. 2B, which is relatively smooth at its outer surface, the coated pultrusion article 200C includes an outer texturized coating layer 214 that includes a texturized outer surface 216. Although the texturized coating layer 214 is shown as being the second, or outermost coating layer in the example coated pultrusion article 200C of FIG. 3C, the texturized outer layer can be on a single-coating layer coated pultrusion article, similar to the coated pultrusion article 200A with the single coating layer 208 as shown in FIG. 2A. The texturized coating layer 214, in an example, can include a matting agent including, but not limited to, plexiglass beads, that can control the overall gloss level of the final coated pultrusion article 200C by creating the texturized outer surface 216, as shown

As described herein, the adhesive tie layer 206 can include an adhesive material that adheres to both the one or more coating layers and to the profile surfaces of the pultrusion substrate 202. In an example, the adhesive tie layer 206 has a thickness from about 1.5 mils (wherein the measurement term “mil,” as used herein, refers to one one-thousandth of an inch, or 0.001 inches) to about 5 mils. In an example, the first coating layer 210 has a thickness from about 3 mils to about 5 mils and the second coating layer 212 has a thickness of about 1 mils to about 5 mils.

The different coated pultrusion articles 200, e.g., having different numbers of coating layers, can provide for different properties based on the intended use of each coated pultrusion article 200. For example, the coated pultrusion article 200A having a single coating layer 208 can be specified for applications that do not require as high of a performance level with respect to weatherability or toughness compared to a two-layer coating 210 and 212 (or 210 and 214) of the coated pultrusion articles 200B and 200C.

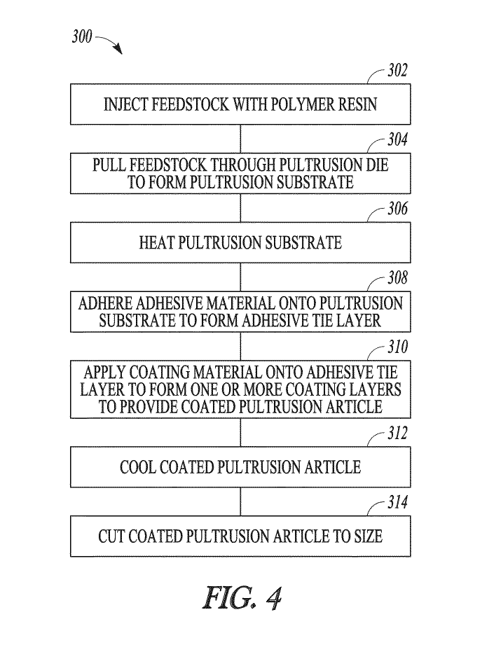

FIG. 4 is a diagram of an example method 300 for coating a substrate, such as a pultrusion substrate, to form a coated article. The method 300 can include, at 302, pulling a feedstock through a pultrusion system, such as the systems of FIGS. 1A and 1B. The method includes, at step 302, injecting a feedstock with a polymer resin to provide a resin-injected feedstock. In an example, resin-injecting the feedstock 302 can include aligning the feedstock prior to injecting the polymer resin, such as by aligning the feedstock from one or more roving.

In an example, the feedstock can comprise one or more reinforcing structures, such as one or more reinforcing fibers. The polymer resin can comprise a composition of one or more resin components. The one or more resin components can be mixed, for example with a mixing apparatus, to form the polymer resin. In an example, the polymer resin comprises a polyurethane-based resin, such as a resin formed from a mixture of one or more polyols and one or more isocyanates. Resin-injecting the feedstock 302 can be performed by one or more injections nozzles, such as the resin nozzles 130 described above. In an example. Resin-injecting the feedstock 302 can be performed, for example, with the resin-injection assembly 110 described above with respect to FIGS. 1A and 1B.

The method 300 can include, at step 304, pulling the resin-injected feedstock through a pultrusion die. The pultrusion die can shape the resin-injected feedstock into a three-dimensional profile shape having one or more profile surfaces. In an example, pulling the feedstock 304 can be performed by the pulling mechanism 164, described above with respect to FIGS. 1A and 1B. The pultrusion die used in the step of pulling the feedstock 304 can be the pultrusion die 112 described above with respect to FIGS. 1A and 1B.

Continuing with FIG. 4, after pulling the feedstock 304, the method 300 can optionally include, at 306, heating the pultrusion substrate, such as to an adhesive-application temperature. The adhesive-application temperature can be a temperature that will enable one or more of: improved adhesion of the adhesive material to the pultrusion substrate or improved formation of the one or more adhesive tie layers. In an example, the adhesive-application temperature to which the pultrusion substrate is heated during heating the pultrusion substrate 306 is at least about 110° F. In an example, the temperature of the pultrusion substrate coming out of the pultrusion die is approximately 180° F., but in some examples, e.g., the pultrusion and coating system 100 of FIG. 1A, by the time it reaches the adhesive-application assembly, the temperature had dropped to approximately 80° F. In an example, heating the pultrusion substrate 306 can include raising the temperature of the pultrusion substrate to at least about 250° F. so that the adhesive material applied to the pultrusion substrate (examples of which are described in more detail above) can sufficiently adhere.

In an example, heating the pultrusion substrate 306 can be performed at the pultrusion die, e.g., with a pultrusion heater. Heating the pultrusion substrate 306 can also include controlling or maintaining the temperature of the pultrusion substrate 104, e.g., through the use of one or more temperature sensors and a control loop to adjust an output of one or more heaters that will heat the pultrusion substrate. In an example, the heating the pultrusion substrate 306 can be performed by the one or more heaters 136 described above with respect to FIG. 1A. In some examples of the method 300, heating the pultrusion substrate 306 can be omitted, for example because the temperature of the pultrusion substrate as it exits the pultrusion die is sufficient for the formation of the one or more adhesive tie layers.

The method 300 can include, at 308, adhering one or more adhesive materials onto at least a portion of the one or more profile surfaces of the pultrusion substrate to form one or more adhesive tie layers on the pultrusion substrate. Adhering the adhesive material 308 can include extruding the one or more adhesive materials onto at least the one or more profile surfaces of the pultrusion substrate, such as through an adhesive extrusion die, for example a cross-head extrusion die. In an example, the adhesive-application assembly 138 described above with respect to FIG. 1A can be used to apply and adhere the one or more adhesive materials, for example with the adhesive die 146 of the adhesive extruder 142.

After adhering the adhesive material 308, the method 300 can include, at 310, applying one or more coating materials onto the one or more adhesive tie layers to form one or more coating layers in order to provide the coated pultrusion article. Applying the coating material 310 can include extruding the one or more coating materials onto the one or more adhesive tie layers, such as through a coating extrusion die. If more than one coating layer is to be applied in the step of applying the coating material 310, then each coating layer can comprise its own coating material or the coating materials of two or more coating layers can be the same or substantially the same. If more than one coating layer is being applied, then each coating layer can be applied by its own coating extrusion die. For example, as shown in FIG. 1A, a first coating material can be extruded through a first coating extruder 148 and a second coating material can be extruded through a second coating extruder 154.

In an example with two or more coating layers, the step of applying the coating material 310 can include co-extruding two or more of the coating layers, or even all of the coating layers. In such an example, applying the coating material 310 of the two or more coating layers can be performed with a co-extrusion die, such as the example co-extrusion die 160 described above with respect to FIG. 1B.

In an example, the step of adhering the adhesive material 308 to form the one or more adhesive tie layers and the step of applying the coating material 310 to form the one or more coating layers can comprise co-extruding the one or more adhesive materials and the one or more coating materials in substantially the same step. In an example, the one or more adhesive materials and the one or more coating materials can be selected to have as closely matching viscosity as possible to optimize adhesion between the co-extruded and adjacent adhesive tie layer and coating layer. In an example, the co-extrusion that combines the steps of adhering the adhesive material 308 and applying the coating material 310 can be performed with a co-extrusion die, such as the example co-extrusion die 160 described above with respect to FIG. 1B.

In an example, two or more of resin-injecting the feedstock 302, pulling the feedstock 304, heating the pultrusion substrate 306 (if performed), adhering the adhesive material 308, and applying the coating material 310 can be conducted in a common in-line continuous process. In an example, all of the steps of resin-injecting the feedstock 302, pulling the feedstock 304, heating the pultrusion substrate 306 (if performed), adhering the adhesive material 308, and applying the coating material 310 are conducted in a common in-line continuous process. A benefit of such a method 300 includes in-line coating a plurality of coating layers to the one or more adhesive tie layers, such as a weathering layer and an aesthetic layer.

In an example, the method 300 can optionally include, at 312, cooling the coated pultrusion article. Cooling the coated pultrusion article 312 can include one or more of: passively exposing the coated pultrusion article to cooling air, such as air at ambient conditions or further chilled air; applying forced air to the coated pultrusion article, for example at ambient temperature or a cooled or chilled temperature; applying a liquid cooling medium to one or more surfaces of the coated pultrusion article, such as by immersing the coated pultrusion article in a cooling immersion bath or by spraying a liquid cooling medium onto one or more surfaces of the coated pultrusion article coated profile.

The method 300 can further include, at 314, cutting the coated pultrusion article to a specified size. Cutting the coated pultrusion article 314 can be performed with any device capable of accurately cutting the elongate coated pultrusion article to a specified size, such as a specified length. Cutting the coated pultrusion article 314 can also include cutting the coated pultrusion article with a specified cutting shape, e.g., a straight cut, a beveled cut, a chamfered cut, a fillet cut, and the like.

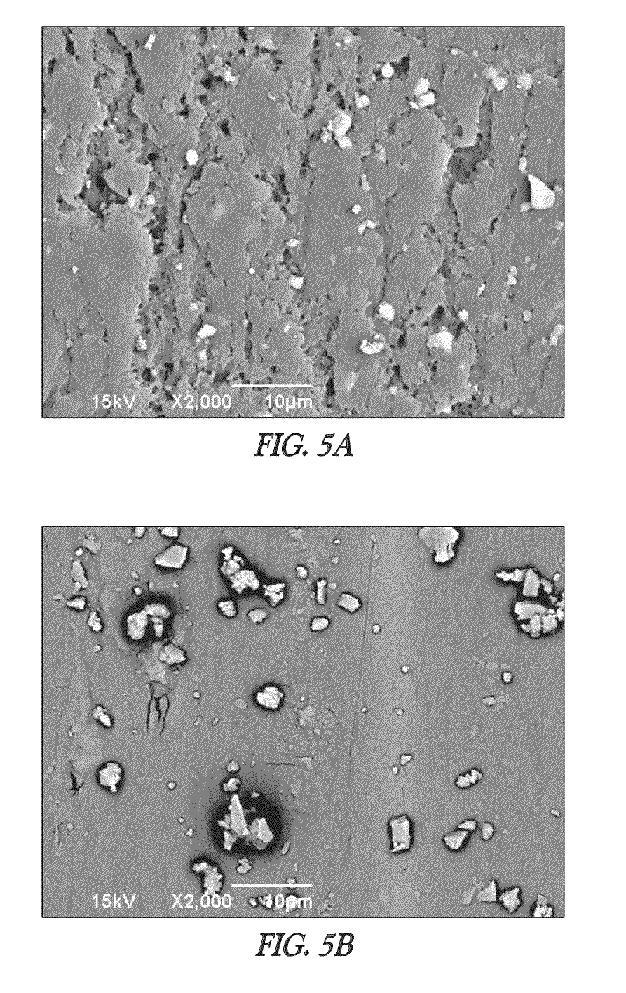

FIGS. 5A and 5B are scanning electron micrographs of a polyester-based pultrusion substrate having a relatively rough surface and a polyurethane-based pultrusion substrate having a relatively smooth surface, respectively. As mentioned above, a challenge with coating relatively smooth pultrusion substrate surfaces as compared to relatively rough pultrusion substrate surfaces is that, in some examples, a relatively smooth surface is much more difficult to bond some coating materials, such as acrylics or clear-coat materials. Relatively rough surfaces, such as those on some polyester-based pultrusion substrates (FIG. 5A), provide more microstructures onto which the coating material can mechanically lock. Highly-smooth surfaces, such as with at least some polyurethane-based pultrusion substrates (FIG. 5B), have fewer and much less pronounced microstructures available for mechanical locking. Surfaces of some substrates, such as at least some polyurethane-based pultrusion substrates, can be less conducive to chemical-based adhesion by some coating materials. The systems and methods described herein provide for one or more adhesive tie layers that substantially improve chemical-based adhesion between coating materials and a highly-smooth pultrusion substrate, such as the surfaces of a polyurethane-based pultrusion substrate.

### EXAMPLES

The present disclosure can be better understood by reference to the examples which are offered by way of illustration. The present disclosure is not limited to the examples given herein.

### Example 1

A copolyamide-based extrudable adhesive material was extruded as an adhesive tie layer onto a two-inch wide strip die profile of a polyurethane-based pultrusion substrate formed under regular processing conditions for a three-dimensional profile. The copolyamide-based adhesive material was co-extruded with a white acrylic material. Non-uniform coating thickness was observed. Preliminary measurement found the acrylic layer to have an average film thickness of 6.5 mils. A boiling-water adhesion test in accordance with AAMA 625-10 was performed excluding the dolly adhesion test. The boiling-water adhesion test resulted in the white acrylic coating being partially delaminated from the extrudable adhesive. However, the polyamide-based extrudable adhesive continued to have good adhesion to the substrate.

### Example 2

The same polyamide-based extrudable adhesive as in EXAMPLE 1 was coextruded with a white acrylic coating material. The extrudable adhesive and the acrylic coating material were coextruded onto a pultrusion substrate formed by pultrusion of a polyurethane-based resin mixture and reinforcing fiber with calcium carbonate (CaCO3) filler included in the polyurethane resin mixture during pultrusion. It was believed that the filler would provide for smoother parts and that the presence of a filler would help improve the adhesion. It was found that the parts filled out better and the bottom was smoother than the top of the parts.

### Example 3

The same polyamide-based extrudable adhesive as in EXAMPLES 1 and 2 was co-extruded with an acrylic material sold under the family of materials sold under the trade name SOLARKOTE H300 by Arkema, Inc. on a two-inch wide strip of a polyurethane-based pultrusion substrate. An array of 250 W overhead lamps was used to raise the temperature of the pultrusion substrate before coating it. The temperature of the adhesive as it was extruded was in the range of about 330 OF to about 350 OF and the acrylic material was extruded at about 470 OF. The appearance of the coated article was significantly smoother than in EXAMPLE 1. The adhesion test with an automatic adhesion tester yielded readings for adhesive strength in the range of about 500 psi. The sample from EXAMPLE 3 failed the boil adhesion test under AAMA 625.

### Example 4

The materials used in EXAMPLE 4 were the same as in EXAMPLE 3, but with a pultrusion die scaled to the characteristics of a polyurethane-based resin. The polyurethane-based resin mixture for the formation of the pultrusion substrate included CaCO₃ as a filler. The copolyamide-based extrudable adhesive was processed at a temperature of about 300° F. The same passed the boil adhesion test which is a requirement as per the AAMA 625 test.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of manufacturing a coated article, the method comprising:
injecting a feedstock with a polymer resin to provide a resin-injected feedstock;
pulling the resin-injected feedstock through a pultrusion die to form a pultrusion substrate having one or more profile surfaces;
adhering one or more adhesive materials onto at least a portion the one or more profile surfaces to form one or more adhesive tie layers on the pultrusion substrate; and
applying one or more coating materials onto the one or more adhesive tie layers to form one or more coating layers on the one or more adhesive tie layers to provide a coated pultrusion article,
wherein an adhesion strength between the one or more coating layers and the one or more adhesive tie layers is higher than a corresponding adhesion strength would be between the one or more coating layers and the pultrusion substrate.

2. The method of claim 1, wherein adhering the one or more adhesive materials onto at least the portion of the one or more profile surfaces comprises extruding the one or more adhesive materials through an adhesive die onto at least the portion of the one or more profile surfaces.

3. The method of claim 1, wherein applying the one or more coating materials comprises extruding the one or more coating materials through a coating-material die onto the one or more adhesive tie layers.

4. The method of claim 1, wherein adhering the one or more adhesive materials and applying the one or more coating materials comprises co-extruding the one or more adhesive materials and the one or more coating materials onto at least the portion of the one or more profile surfaces.

5. The method of claim 1, further comprising cooling the coated pultrusion article.

6. The method of claim 1, wherein the polymer resin comprises a polyurethane-based resin.

7. The method of claim 1, further comprising heating the pultrusion substrate to an adhesive-application temperature prior to adhering the one or more adhesive materials onto at least the portion of the one or more profile surfaces.

8. A pultrusion system comprising:
a resin-injection assembly to inject a feedstock with a polymer resin to provide a resin-injected feedstock;
a pultrusion die to shape the resin-injected feedstock into a pultrusion substrate having one or more profile surfaces; and
a coating system comprising:
an adhesive-application assembly to apply one or more adhesive materials onto at least a portion of the one or more profile surfaces of the pultrusion substrate to form one or more adhesive tie layers, and
a coating-material application assembly to apply one or more coating materials onto the one or more adhesive tie layers to form one or more coating layers in order to provide a coated pultrusion article.

9. The pultrusion system of claim 8, wherein the resin-injection assembly comprises a resin-mixing system comprising:
a first resin storage vessel for a first resin constituent;
a second resin storage vessel for a second resin constituent; and
a mixing apparatus communicatively coupled to the first resin storage vessel and the second resin storage vessel to mix the first resin constituent and the second resin constituent to provide the polymer resin.

10. The pultrusion system of claim 8, wherein the polymer resin comprises a polyurethane-based resin.

11. The pultrusion system of claim 8, wherein the adhesive-application assembly comprises an adhesive extruder having an adhesive die to apply the one or more adhesive materials to form each of the one or more adhesive tie layers.

12. The pultrusion system of claim 8, wherein the coating-material application assembly comprises a coating-material extruder having a coating-material die to apply the one or more coating materials to form each of the one or more coating layers.

13. The pultrusion system of claim 8, wherein the adhesive-application assembly and the coating-material application assembly comprise a co-extrusion die communicatively coupled to an adhesive extruder and to a coating-material extruder, wherein the co-extrusion die applies both:
the one or more adhesive materials onto at least the portion of the one or more profile surfaces of the pultrusion substrate to form the one or more adhesive tie layers; and
the one or more coating materials onto the one or more adhesive tie layers to form the one or more coating layers.

14. The pultrusion system of claim 8, wherein the coating-material application assembly comprises:
a first coating-material extruder to apply a first coating material onto the one or more adhesive tie layers to form a first coating layer; and
a second coating-material extruder to apply a second coating material onto the one or more first coating layers to form a second coating layer.

15. The pultrusion system of claim 8, further comprising a finishing system, including:
a cooling assembly to cool the coated pultrusion article;
a pulling mechanism to pull the feedstock through the pultrusion die; and
a cutting mechanism to cut the coated pultrusion article to a specified size.

16. The pultrusion system of claim 8, further comprising a line-heating element interposed between the pultrusion die and the adhesive-application assembly to heat the pultrusion substrate to a specified adhesive-application temperature upstream of the adhesive-application assembly.

17. A coated article comprising:
a composite substrate formed from a reinforcing feedstock at least partially embedded in a matrix polymer, the composite substrate including a center portion and a peripheral portion at least partially surrounding the center portion, the peripheral portion having a greater concentration of the matrix polymer than the center portion;
one or more adhesive tie layers disposed along at least a portion of the peripheral portion of the composite substrate; and
one or more coating layers disposed above the one or more adhesive tie layers, the one or more adhesive tie layers providing an adhesive interface between the composite substrate and the one or more coating layers, wherein an adhesion strength between the one or more coating layers and the one or more adhesive tie layers is higher than a corresponding adhesion strength would be between the one or more coating layers and the peripheral portion of the composite substrate.

18. The coated article of claim 17, wherein at least one of the one or more coating layers comprises an acrylic.

19. The coated article of claim 17, wherein the one or more coating layers includes one or more clear-coat layers.

20. The coated article of claim 19, wherein at least one of the one or more clear-coat layers comprises an acrylic material.

21. The coated article of claim 19, wherein the one or more coating layers comprise at least one acrylic-containing layer disposed between the one or more clear-coat layers and the one or more adhesive tie layers.

22. The coated article of claim 17, wherein the one or more coating layers have a total thickness of from about 3 mils to about 15 mils.

23. The coated article of claim 17, wherein at least one of the one or more coating layers includes a coloring additive.

24. The coated article of claim 17, wherein at least a portion of an outer surface of the one or more coating layers is texturized.

25. The coated article of claim 17, wherein the one or more adhesive tie layers substantially overcome a difference in surface energies between the one or more coating layers and the composite substrate.
